(19) United States
(12) Patent Application Publication
(10) Pub. No.: US 2007/0091718 A1
(43) Pub. Date: Apr. 26, 2007

(54) Splatter guard

(76) Inventors: Peter Browne, Aurora (CA); David Green, Toronto (CA); David Chan, Scarborough (CA)

Correspondence Address: Gowling Lafleur Henderson LLP;Suite 1600, 1 First Canadian Place, 100 King Street West, Toronto, ON, M5X 1G5, CA

(21) Appl. No.: 11/253,680

(22) Filed: Oct. 20, 2005

(51) Int. Cl. B01F 15/00

(52) U.S. Cl. 366/347; 220/731

(57) ABSTRACT

The present invention provides a splatter guard having an elastic sizing ring for adapting the splatter guard for use on mixing bowls of varying size.

### FIELD OF THE INVENTION

The present invention relates to a splatter guard and more particularly a splatter guard for use on a mixing bowl.

### BACKGROUND OF THE INVENTION

The invention relates to a splatter guard for use on mixing bowls of varying size. Mixing bowls are used in the culinary field for combining ingredients or for changing the form of a particular ingredient, for example in the case of beating an egg or whipping cream. The mixing action or processing of these ingredients may be manual or automatic, e.g. electric hand mixer or stationary mixer, and may be undertaken at a variety of speeds.

The mixing or processing action, in particular when at faster speeds, can often lead to the ingredients being thrown from the bowl. For example, when using an electric hand whisk for whipping cream often the cream will be flung from the electric beaters if not completely submerged in the cream.

Some mixers do include a splatter guard to prevent excessive loss of ingredients, however, generally these splatter guards are product specific and are not adaptable for use with other mixing bowls. Others provide a small aperture that is specific for the mixing utensil provided with the mixer and therefore are not adaptable for use in, for example, a manual mixing setting.

### SUMMARY OF THE INVENTION

In one aspect the present invention provides a splatter guard for use on mixing bowls of varying size. The splatter guard of the present invention includes a sizing ring having an adjustable position to provide a secure fit between the splatter guard and the mixing bowl with which it is to be used.

The present invention provides a splatter guard for a mixing bowl comprising a cover portion having a wall depending from a bottom surface and at least one elastic sizing ring positioned between the wall and an inner surface of the mixing bowl.

In a further aspect the present invention provides a sizing ring for use with a splatter guard on a mixing bowl, wherein the sizing ring is flexible and has a first surface adapted for engagement with the splatter guard and a second surface adapted for engagement with an internal surface of a mixing bowl.

In a another aspect the present invention provides a method of using an adaptable splatter guard with containers of varying sizes, the splatter guard having a cover portion, a depending wall extending from the cover portion and a sizing ring. The method comprises the steps of (i) identifying the diameter of the container opening; (ii) identifying a position on the wall of the splatter guard that corresponds to the diameter of the container; (iii) placing the sizing ring at the position identified in step (ii); and (iv) placing the splatter guard on the container so that the sizing ring engages with at least a portion of the internal surface of the container.

In a further aspect the present invention provides a sizing ring for use with a splatter guard on a mixing bowl, wherein the sizing ring is flexible and has a first surface adapted for engagement with an external surface of the splatter guard and a second surface adapted for engagement with an internal surface of a mixing bowl

### BRIEF DESCRIPTION OF THE DRAWINGS

The present invention will be described in more detail below with reference to the accompanying drawings in which:

FIG. 1 is an isometric view of the underside of the splatter guard of the present invention showing the cover portion and the sizing ring in a lower position;

FIG. 2 is an isometric view of the splatter guard showing the cover portion;

FIG. 3 is a top view of the splatter guard;

FIG. 4A is a cross sectional view of the splatter guard of FIG. 3 taken along the line 4-4 showing the sizing ring in a first lower position;

FIG. 4B is a cross sectional view of the splatter guard of FIG. 3 taken along the line 4-4 showing the sizing ring in a second higher position;

FIG. 4C is a magnified view of portion C identified in FIG. 4A;

FIG. 5A is a side view of the splatter guard showing the sizing ring in a first lower position;

FIG. 5B is a side view of the splatter guard showing the sizing ring in a second higher position;

FIG. 6 is a side view of the cover portion of the splatter guard without the sizing ring;

FIG. 7 is a cross sectional view of the cover portion of FIG. 6 taken along the line 7-7;

FIG. 8 is an isometric view of the sizing ring of the splatter guard;

FIG. 9 is a cross sectional view of the sizing ring of FIG. 8 taken along the line 9-9;

FIG. 10 is a side view of the sizing ring of FIG. 8;

FIG. 11 is an isometric view of the splatter guard of the present invention in use on a bowl; and

FIG. 12 is a cross sectional side view of the splatter guard and bowl of FIG. 11, taken along the line 12-12, showing engagement of the sizing ring with an internal surface of the bowl.

### DETAILED DESCRIPTION OF THE PREFERRED EMBODIMENTS

The present invention provides a splatter guard for use on mixing bowls of varying size. The splatter guard includes an elastic sizing ring the position of which can be adjusted to provide a frictional fit between the splatter guard and the bowl with which it is to be used.

The present invention will be described in more detail with reference to the drawings in which the splatter guard is indicated generally at numeral 10. The use of the splatter guard 10 will be described below with reference to an example of a mixing bowl 40 with which it may be used.

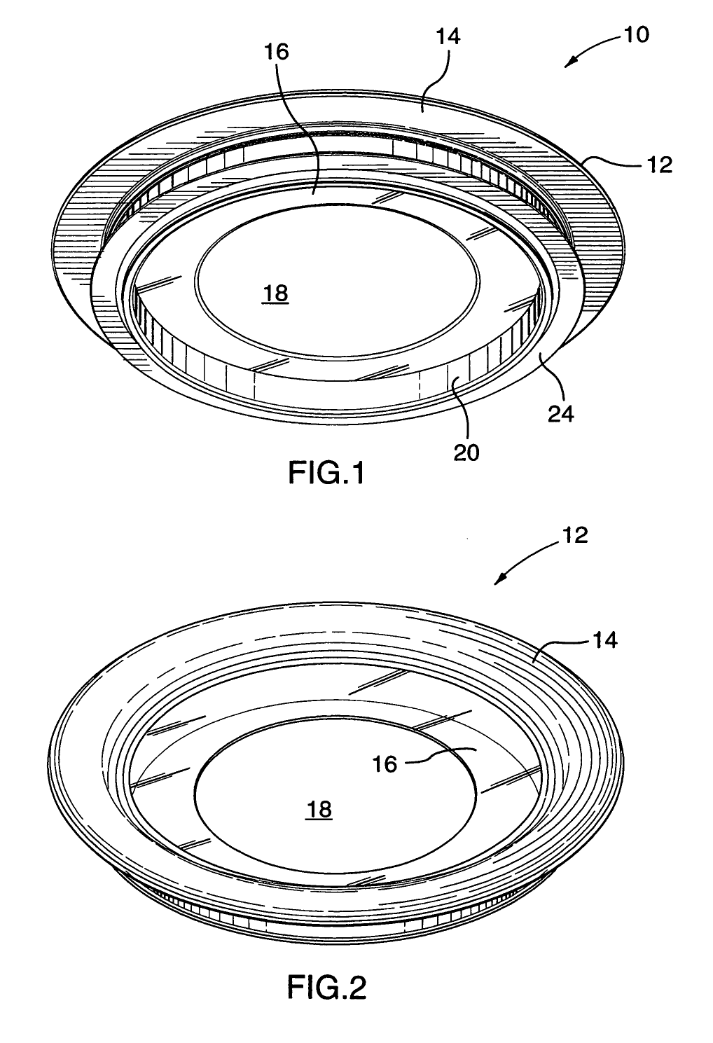

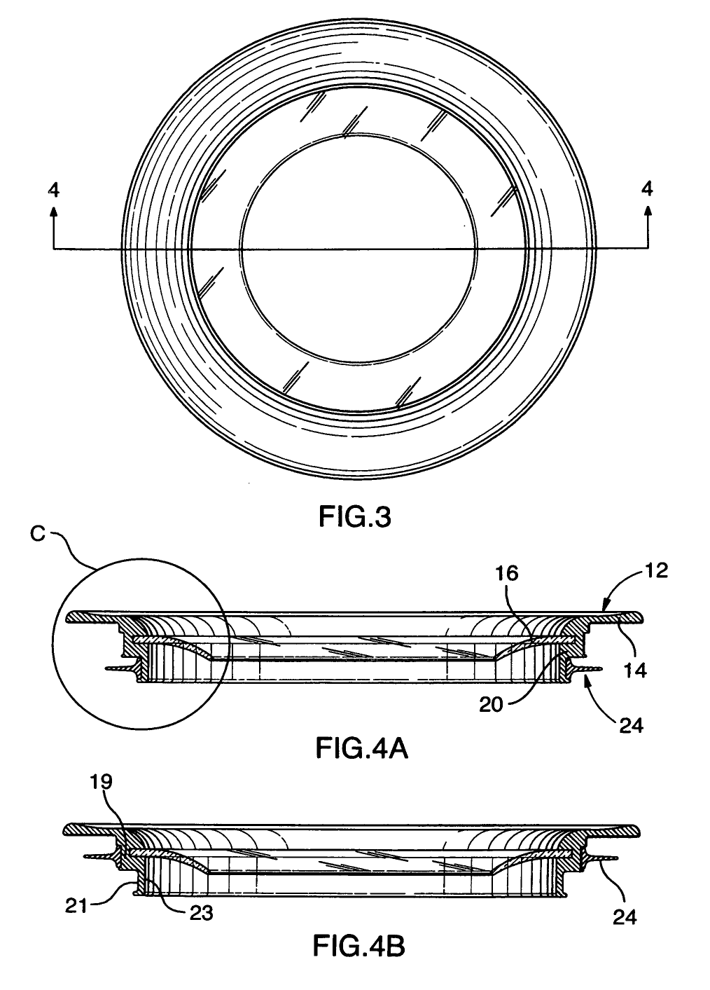

Referring now to FIGS. 1 and 2, the splatter guard 10 includes a cover portion 12 having an outer rigid portion 14 and an inner flexible portion 16. The inner flexible portion 16 defines a central aperture 18. In a preferred embodiment the outer rigid portion 14 is made of a rigid thermoplastic material. Examples of thermoplastic material that may be used include, but are not limited to polycarbonate, acrylic and polyproylene. Preferably the outer rigid portion 14 is made from a low grade polypropylene. In the preferred embodiment the inner flexible portion 16 is made of a flexible thermoplastic material, preferably a thermoplastic elastomer and more preferably a transparent thermoplastic elastomer. The transparency of the material of the inner portion 16 allows a user to view the ingredients within the mixing bowl which may be necessary in order for the user to assess whether to increase or decrease the speed of mixing/processing or to stop the mixing/processing.

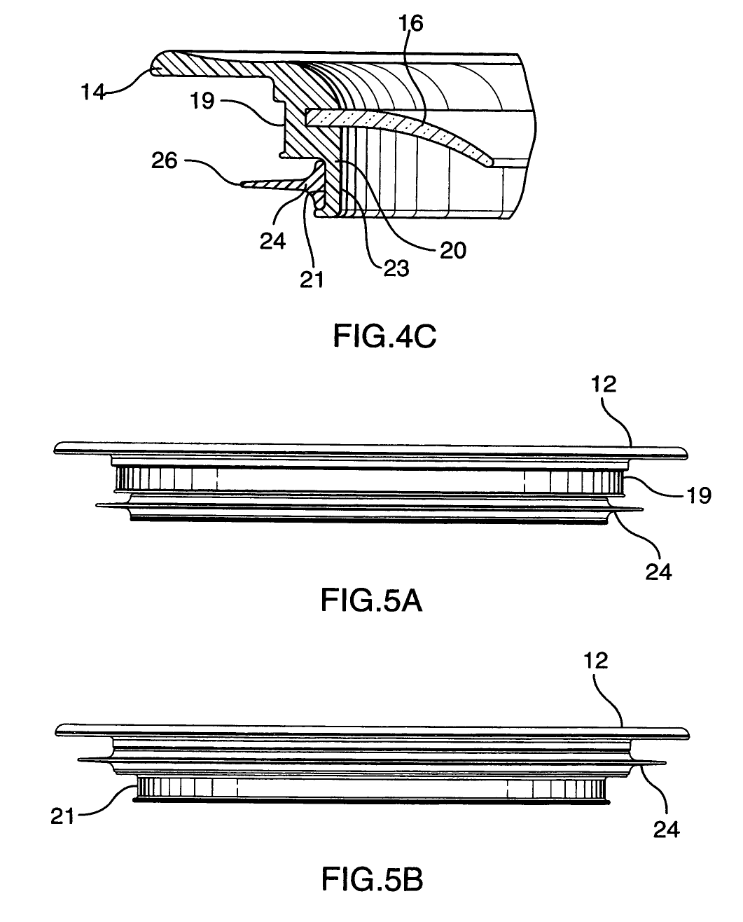

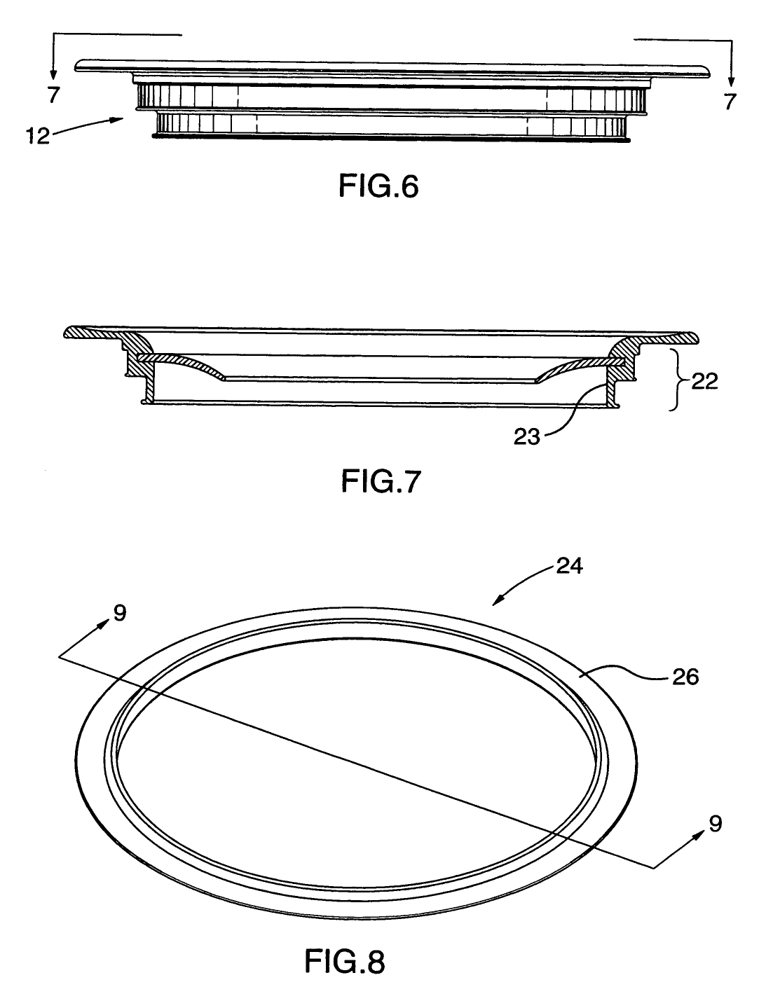

As can be seen more clearly in FIG. 4A, extending from the lower surface of the cover portion 12 is a wall 20. In the illustrated embodiment, the wall 20 is circular. The wall includes an external surface 22 and an internal surface 23. It will be understood by a person skilled in the art that reference to the lower surface of the cover portion means the lower surface when in use, i.e. the surface that faces the bowl with which the splatter guard 10 is to be used. In the embodiment illustrated, the outer rigid portion 14 and the wall 20 are integrally formed and the outer rigid portion 14 slopes inwardly and extends down to form the wall. However, it will be understood that these two pieces could be formed separately and attached using means known in the art.

The thickness of the wall 20 decreases as the wall extends away from the lower surface of the cover portion 12. The decreasing thickness of the wall 20 is achieved by varying the topography of the external surface 22 while maintaining the location of the internal surface 23. As can be seen in FIG. 4C the internal surface 23 extends from the cover portion 12 in a substantially straight line, whereas the external surface 22 extends from the lower surface is inwardly stepped towards the internal surface 23. The stepped external surface 22 means that the area defined by the circular wall has different diameters at different distances from the cover portion. The different external diameters created by the varying thickness of the wall 20 allows the splatter guard to be used with containers of varying sizes.

In general containers/mixing bowls are available in many different sizes and vary in volume and diameter, the splatter guard of the present invention can be adapted to fit on such containers/bowls. When the splatter guard is used on bowls with small internal diameters, the splatter guard may only extend a short distance into the bowl and therefore the sizing ring may be placed around the lowest portion of the wall 20 so that it will engage with the internal surface of the bowl. For bowls having larger diameters, the splatter guard will extend further into the bowl. Therefore the sizing ring will be placed around the portion of the wall 20 closest to the cover portion 12 so that it engages with the inner surface of the bowl.

As can be seen in FIG. 4A the wall 20 extends from an inner edge of the outer portion 14 at the point where the inner flexible portion 16 and the outer rigid portion 14 meet. However, it will be understood that the wall 20 may be attached to any portion of the outer rigid portion 14 provided that at least a portion of the outer rigid portion 14 extends beyond the circumference of the wall 20 so that the outer rigid portion 14 will extend beyond the circumference of any bowl with which it is to be used.

In the embodiment shown in the Figures, and as can be seen clearly in FIG. 4C, the external surface 22 of the wall 20 is stepped inwardly as the wall 20 extends away from the outer rigid portion 14. The splatter guard 10 also includes an elastic sizing ring 24. The elastic sizing ring 24 is operable to releasably attach to any circumferential portion of the external surface 22. In the embodiment illustrated, the sizing ring 24 is sized to attach to any one of the steps defined by the external surface 22.

It will be understood by a person skilled in the art that the external surface 22 is not limited to a series of steps and can take any shape or form that provides a decreasing outer circumferential length as the wall 20 extends away from the cover portion 12. For example, the external surface 22 could be sloped inwardly and include projections or ledges along the surface between which the sizing ring 24 may be held in place.

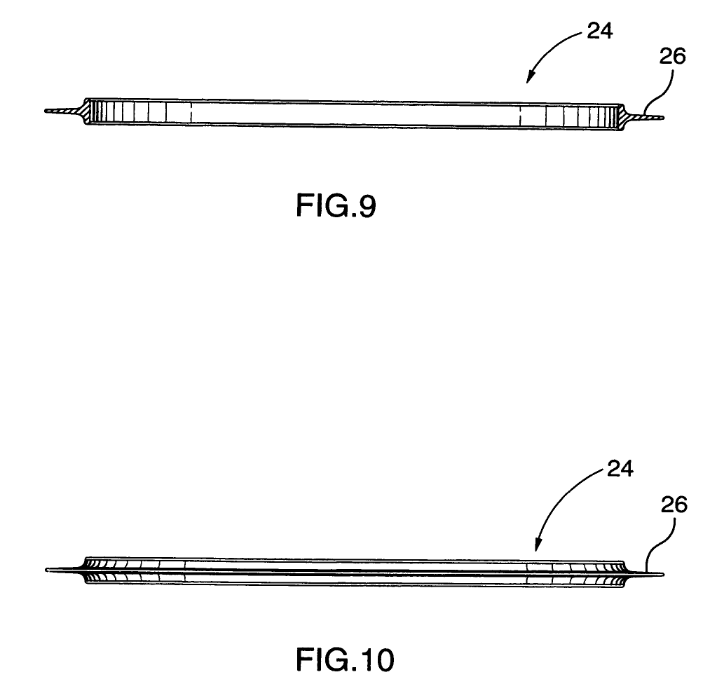

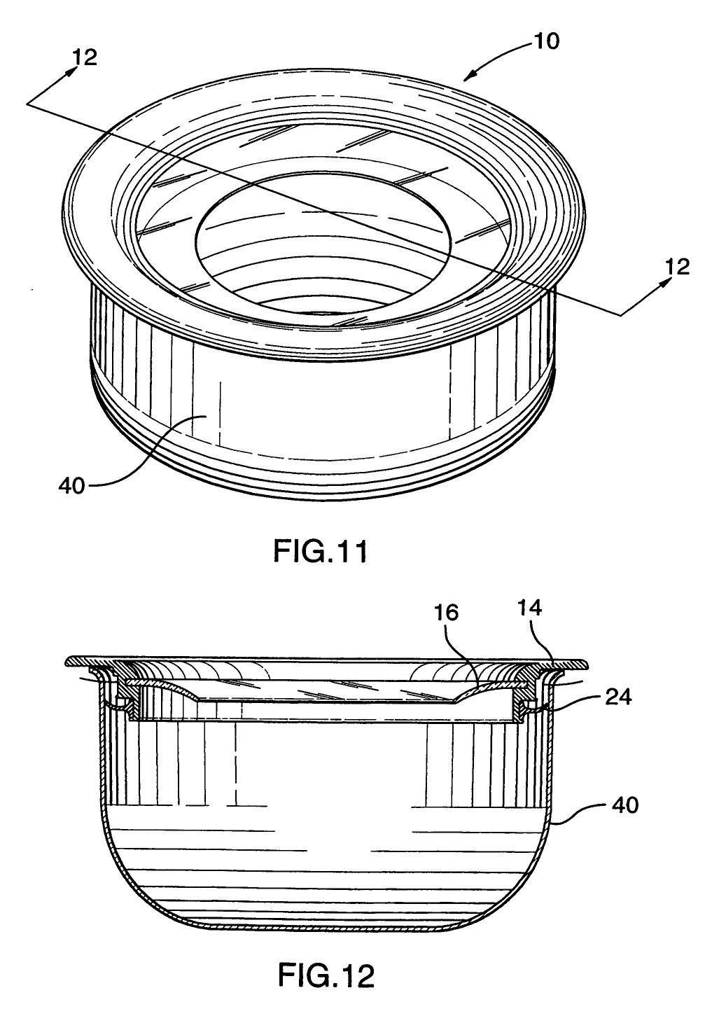

The sizing ring 24 is clearly shown in FIGS. 8 through 10 and includes an outwardly extending flexible projection 26 for frictional engagement with at least a portion of the internal surface of the mixing bowl, shown in FIG. 12 and described further below. As can be seen in the Figures, the flexible projection 26 extends from a central location on the outer surface of the sizing ring 24. However, it will be understood that the flexible projection 26 may extend from any portion of the outer surface of the sizing ring 24 provided that it is able to engage an inner surface portion of the bowl. Further, it will be understood that the flexible projection does not have to extend around the entire circumference of the sizing ring 24 but may be a series of projections extending at intervals around the outer surface.

The sizing ring 24 is made from an elastic material so that it can stretch and contract to attach around the circumferential edge at varying positions along the external surface 22 of the wall 20. Examples of elastic material that may be use include, but are not limited to, thermoplastic elastomer, santoprene and thermoplastic resin. Preferably the sizing ring 24 is made from silicone. The elastic material from which the sizing ring 24 is made allows the sizing ring 24 to stretch around the wider portion 19 of the wall 20, i.e. closer to the cover portion 12 as shown in FIG. 5B, and to contract around the thinner portion 21 of the wall 20, i.e. farthest from the cover portion 12 as shown in FIG. 5A.

In an alternative embodiment of the invention, the splatter guard 10 may include more than one sizing ring 24. Each sizing ring 24 may be sized to fit around a particular portion of the external surface 22 of the wall 20. For example, in the embodiment described above in which the external surface 22 includes a series of steps, each sizing ring 24 may be sized to fit around one particular step. Additionally, each sizing ring 24 may be a different colour so that a user can easily differentiate between rings and identify the one to use.

In one embodiment of the splatter guard 10 of the present invention the outer rigid portion 14 and the inner flexible portion 16 are independently formed and then attached to each other during manufacturing of the splatter guard 10. The joining of the two pieces may be made using techniques known by a person skilled in the art, including but not limited to, adhesive attachment. Alternatively, the two portions may be releasably attached to each other, for example, the inner flexible portion 16 may be received in a slot located in the outer rigid portion 14 or they may be connected by way of a snap fit. Alternatively they may be attached by over moulding the outer rigid portion 14 on the inner flexible portion 16. In an alternative embodiment the outer rigid portion 14 and the inner flexible portion 16 are integrally formed. Other methods of attaching the portions will be known by a person skilled in the art.

Turning to FIGS. 11 and 12 the use of the splatter guard on a bowl, indicated at numeral 40, will now be described. It will be understood by a person skilled in the art that the splatter guard of the present invention may be manufactured in different sizes in order to fit different bowl types while still having the features described in the specification.

Prior to placing the splatter guard 10 on the bowl 40 with which it is to be used, the user may assess the bowl size and position the sizing ring 24 accordingly. For example, if the bowl is small the sizing ring 24 may be placed around the lowest part/step of the external surface 22, as shown in FIG. 16, whereas if the bowl is large the sizing ring 24 may be placed around the part/step that is closest to the outer rigid portion 14. Once the sizing ring is in place the splatter guard 10 may be positioned on the bowl. The splatter guard 10 is positioned so that the wall 20 extends into the bowl. As the splatter guard 10 is placed on the bowl the extending flexible projection 26 of the sizing ring 24 comes into frictional engagement with the bowl. The splatter guard 10 may be pushed onto the bowl 40 until the outer rigid portion 14 abuts the top of the bowl. The sizing ring 24 provides a frictional seal between the bowl 40 and the splatter guard 10 and prevents the splatter guard 10 from moving within the bowl.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments. Further, all of the claims are hereby incorporated by reference into the description of the preferred embodiments.

All publications, patents and patent applications referred to herein are incorporated by reference in their entirety to the same extent as if each individual publication, patent or patent application was specifically and individually indicated to be incorporated by reference in its entirety.

What is claimed is:

1. A splatter guard for a mixing bowl comprising:
a cover portion having a wall depending from a bottom surface thereof; and
at least one elastic sizing ring positioned between the wall and an inner surface of the mixing bowl.

2. The splatter guard according to claim 1, wherein the at least one sizing ring comprises a first surface for engagement with the wall of the cover portion and a projection extending outwardly therefrom.

3. The splatter guard according to claim 1, wherein the wall includes a series of positions for receiving the at least one ring thereon.

4. The splatter guard according to claim 1, wherein the wall is stepped.

5. The splatter guard according to claim 1, wherein the wall includes a plurality of projections positioned to receive the at least one ring there between.

6. The splatter guard according to claim 1, wherein the wall is substantially circular.

7. The splatter guard according to claim 1, wherein the cover portion comprises an outer rigid portion and an inner flexible portion.

8. The splatter guard according to claim 7, wherein the inner flexible portion is transparent.

9. The splatter guard according to claim 1, wherein the cover portion defines a central aperture.

10. A splatter guard for a mixing bowl comprising:
a cover portion defining a central aperture and including a wall depending from a lower surface thereof; and
at least one elastic sizing ring adapted to attach to an external surface of the wall, the sizing ring being operable to frictionally engage at least a portion of an internal surface of the mixing bowl.

11. The splatter guard according to claim 10, wherein the cover portion comprises an outer rigid portion and an inner flexible transparent portion.

12. The splatter guard according to claim 1, wherein the external surface comprises at least two stepped portions.

13. The splatter guard according to claim 1, wherein the outer rigid portion and the inner flexible portion are integral.

14. The splatter guard according to claim 1, wherein the inner flexible portion is releasably attached to the outer rigid portion.

15. The splatter guard according to claim 1, wherein the wall extends from an inner edge of the outer rigid portion.

16. The splatter guard according to claim 1, wherein the external surface of the wall comprises a series of steps having decreasing circumferential lengths.

17. The splatter guard according to claim 12, wherein the at least one sizing ring is operable to attach to any one of the steps.

18. The splatter guard according to claim 1, wherein the at least one elastic sizing ring is releasably attached to the external surface of the wall.

19. A sizing ring for use with a splatter guard on a mixing bowl, wherein the sizing ring is flexible and has a first surface adapted for engagement with an external surface of the splatter guard and a second surface adapted for engagement with an internal surface of a mixing bowl.

20. A method of using an adaptable splatter guard with containers of varying sizes, the splatter guard having a cover portion, a depending wall extending from the cover portion and a sizing ring, comprising the steps of:
(i) identifying the diameter of the container opening;
(ii) identifying a position on the wall of the splatter guard that corresponds to the diameter of the container;
(iii) placing the sizing ring at the position identified in step (ii); and
(iv) placing the splatter guard on the container so that the sizing ring engages with at least a portion of the internal surface of the container.
